(19) United States
(12) Patent Application Publication
(10) Pub. No.: US 2008/0016457 A1
(43) Pub. Date: Jan. 17, 2008

(54) CHARACTER INPUT DEVICE, CHARACTER INPUT METHOD, AND INFORMATION STORAGE MEDIUM

(75) Inventors: Makoto Tabuchi, Tokyo (JP); Koichi Sato, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc., Minato-ku (JP)

(21) Appl. No.: 11/734,736

(22) Filed: Apr. 12, 2007

(30) Foreign Application Priority Data
May 1, 2006 (JP) 2006-127939

(51) Int. Cl. G06F 3/048

(52) U.S. Cl. 715/773

(57) ABSTRACT

To realize a readily understandable character input interface which does not need many physical keys, a character input device comprises a character input interface image display section for displaying a character input interface image which contains a plurality of key images (a key image alignment) each associated with one or more characters and a list showing one or more character strings; a distinctive display section for selectively and distinctively displaying, using a cursor, one of the plurality of key images and the one or more character strings shown in the list according to a direction operation carried out by the user; an input character string display section for displaying, when one of the plurality of key images is distinctively displayed by the distinctive display section when the user carries out an input operation, one of the characters associated with the key image in a character string display area, and displaying, when one of the one or more character strings is distinctively displayed by the distinctive display section when the user carries out the input operation, the character string in the input character string display area.

### CROSS REFERENCE TO RELATED APPLICATION

The present application claims priority from Japanese Application No. 2006-127939, filed May 1, 2006, the disclosure of which is hereby incorporated by reference herein in its entirety.

### BACKGROUND OF THE INVENTION

1. Field of the Invention

The present invention relates to a character input device, a character input method, and an information storage medium, and in particular to a character input interface which is formed by combining a software keyboard and an input character prediction method.

2. Description of the Related Art

There is known an input character prediction technique for providing an advantage of reducing the number of times the user carries out a key input operation to input characters. According to this technique, a character string which the user is going to input is predicted based on the character information having been definitively input by the user, and a list showing the predicted character strings is displayed. Thereafter, when the user designates one of the predicted character strings shown in the displayed list, the designated one is determined as the input character string which the user is going to input. A technique for predicting input characters is used to predict an English word based on alphabetic character information, or a sentence consisting of kana and Chinese characters based on Japanese hiragana and/or katakana.

A conventional input character prediction technique is often applied to a device, such as a character input interface for a portable phone, and so forth, which has a relatively large number of physical keys (physical operation members). Such a device has, besides keys for use by the user to input character information, keys for use by the user to designate a desired one of the predicted character strings displayed in the list.

On the contrary, a character input interface referred to as a software keyboard does not need a key arrangement consisting of many physical keys. With this character input interface, an image representative of a key arrangement is displayed on the monitor, so that the user carries out a direction operation using a direction key or the like to selectively and distinctively display any of the key images. Then, the user inputs a character associated with that key image through an input operation using a button or the like. Therefore, a software keyboard can be a potent candidate as a character input interface to be employed by a device, such as a game device or the like, which does not have many physical keys.

In this case, it is desirable that the above-described input character prediction technique is additionally employed to reduce the number of times the user carries out a key input operation to input a character.

However, for a device employing a software keyboard, it is difficult to separately provide a physical key for use by the user to designate one of the predicted character strings shown in the list. Besides, if it can be arranged such that not only input of character information but also designation of a predicted character string can be achieved through a direction operation using a direction key or the like and an input operation using a button or the like, the operation can be so simplified that a character input interface readily understandable by the user can be realized.

The present invention has been conceived in view of the above, and an object thereof is to provide a character input device having a readily understandable character input interface without the need for many physical keys, a character input method therefor, and an information storage medium therefor.

### SUMMARY OF THE INVENTION

In order to solve the above described problems, according to one aspect of the present invention, there is provided a character input interface image display means for displaying a character input interface image which contains a plurality of key images each associated with one or more characters and a list showing one or more character strings; distinctive display means for selectively and distinctively displaying one of the plurality of key images and the one or more character strings shown in the list according to a direction operation carried out by the user; input character string display means for displaying, when one of the plurality of key images is distinctively displayed by the distinctive display means when the user carries out an input operation, one of the characters associated with the key image in a character string display area, and displaying, when one of the one or more character strings is distinctively displayed by the distinctive display means when the user carries out the input operation, the character string in the input character string display area.

In the above, the character input device may further comprise list production means for producing the list showing one or more character strings based on the character string displayed in the input character string display area.

In the above, the distinctive display means may store, when a distinctive display object is changed from one of the plurality of key images to one of the one or more character strings, display position information concerning a display position of a key image which is the distinctive display object before the change, and determines, when the distinctive display object is changed from one of the one or more character strings to one of the plurality of key images, a key image which is the distinctive display object after the change according to the display position information.

According to another aspect of the present invention, there is provided a character input method, comprising a character input interface image displaying step of displaying a character input interface image which contains a plurality of key images each associated with one or more characters and a list showing one or more character strings; a distinctive display step of selectively and distinctively displaying one of the plurality of key images and the one or more character strings shown in the list according to a direction operation carried out by the user; and an input character string displaying step of displaying, when one of the plurality of key images is distinctively displayed at the distinctively display step when the user carries out an input operation, one of the characters associated with the key image in a character string display area, and displaying, when one of the one or more character strings is distinctively displayed at the distinctive display step when the user carries out the input operation, the character string in the input character string display area.

According to still another aspect of the present invention, there is provided an information storage medium storing a program for causing a computer to function as character input interface image display means for displaying a character input interface image which contains a plurality of key images each associated with one or more characters and a list showing one or more character strings; distinctive display means for selectively and distinctively displaying one of the plurality of key images and the one or more character strings shown in the list according to a direction operation carried out by the user; and input character string displaymeans for displaying, when one of the plurality of key images is distinctively displayed by the distinctive display means when the user carries out an input operation, one of the characters associated with the key image in a character string display area, and displaying, when one of the one or more character strings is distinctively displayed by the distinctive display means when the user carries out the input operation, the character string in the input character string display area.

It should be noted that the computer may be a variety of game devices, a portable phone, a portable digital assistant, or a personal computer. The program may be stored in an information storage medium which can be read by the computer.

### BRIEF DESCRIPTION OF THE DRAWINGS

FIG. 1 is diagram showing a hardware structure of an entertainment system used as a character input device according to an embodiment of the present invention;

FIG. 2 is diagram showing a detailed structure of an MPU;

FIG. 3 is a perspective view showing one example of a controller;

FIG. 4 is a diagram showing one example of a character input interface image shown in the monitor;

FIG. 5 is a diagram showing one example of a character input interface image shown in the monitor;

FIG. 6 is a diagram showing one example of a character input interface image shown in the monitor;

FIG. 7 is a functional block diagram showing a character input device according to the embodiment of the present invention; and

FIG. 8 is a diagram showing a modified example of a character input interface image shown in the monitor.

### DESCRIPTION OF THE PREFERRED EMBODIMENTS

In the following, one embodiment of the present invention will be described in detail with reference to the accompanying drawings.

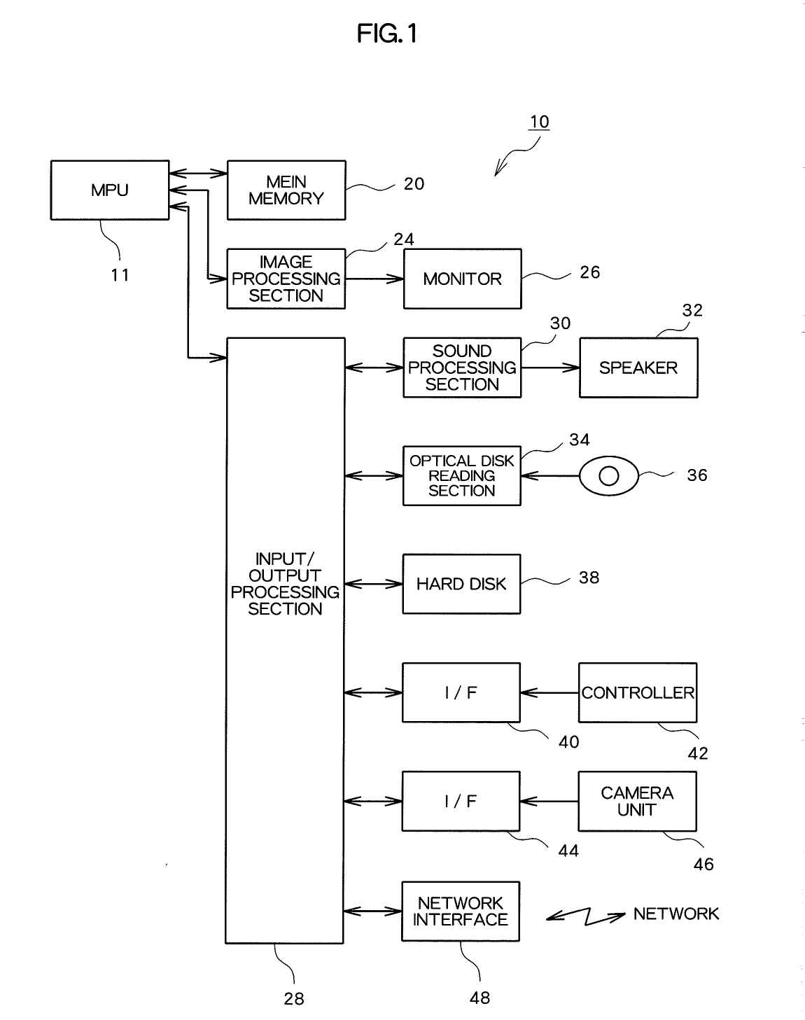

FIG. 1 is a diagram showing a hardware structure of an entertainment system (a character input device) according to this embodiment. As shown in FIG. 1, the entertainment system 10 is a computer system constructed comprising an MPU (Micro Processing Unit) 11, a main memory 20, an image processing section 24, a monitor 26, an input output processing section 28, a sound processing section 30, a speaker 32, an optical disc reading section 34, an optical disc 36, a hard disk 38, interfaces (I/F) 40, 44, a controller 42, a camera unit 46, and a network interface 48.

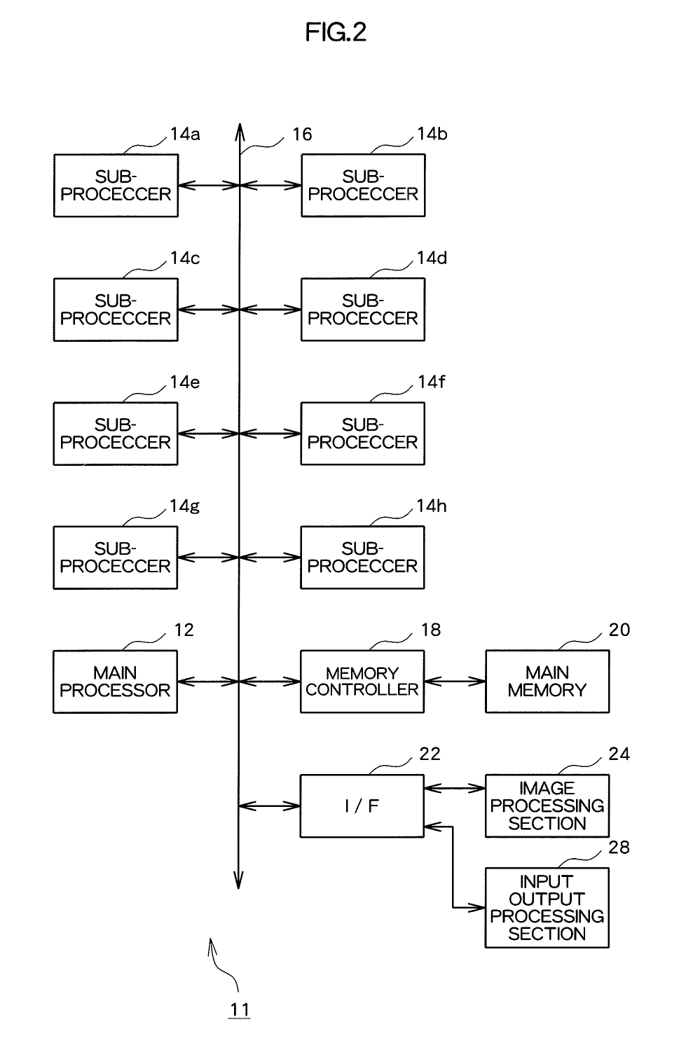

FIG. 2 is a diagram showing a structure of the MPU 11. As shown in FIG. 2, the MPU 11 is constructed comprising a main processor 12, sub-processors 14a, 14b, 14c, 14d, 14e, 14f, 14g, and 14h, a bus 16, a memory controller 18, and an interface (I/F) 22.

The main processor 12 carries out various information processing based on an operation system stored in the ROM (Read Only Memory) (not shown), a program and data read from an optical disc 36, such as a DVD (Digital Versatile Disk)-ROM or the like, for example, and a program and data, and so forth, supplied via a communication network, and effects control relative to the sub-processors 14a through 14h.

According to an instruction sent from the main processor 12, the sub-processors 14a through 14h carry out various information processing, and effect control of the respective sections of the entertainment system 10 based on a program and data read from the optical disc 36 such as a DVD-ROM, or the like, for example, and a program and data and so forth supplied via a communication network.

The bus 16 is used to exchange an address and data among the respective sections of the entertainment system 10. The main processor 12, the sub-processors 14a through 14h, the memory controller 18, and the interface 22 are connected with one another via the bus 16 for mutual data exchange.

The memory controller 18 accesses the main memory 20 according to instructions sent from each of the main processor 12 and the sub-processors 14a through 14h. A program and data read from the optical disc 36 and/or the hard disk 38 and/or a program and data supplied via the communication network are written into the main memory 20, as required. The main memory 20 is used as a working memory for the main processor 12 and the sub-processors 14a through 14h.

The image processing section 24 and the input output processing section 28 are connected to the interface 22. Data is exchanged between the main processor 12 and the sub-processors 14a through 14h and the image processing section 24 or the input output processing section 28 via the interface 22.

The image processing section 24 is constructed comprising a GPU (Graphical Processing Unit) and a frame buffer. The GPU renders various screen images into the frame buffer based on the image data supplied from the main processor 12 and/or the sub-processors 14a through 14h. The screen image formed in the frame buffer is converted into video signal at predetermined timings and output to the monitor 26. It should be noted that the monitor 26 may be a home-use television set receiver, for example.

The sound processing section 30, the optical disc reading section 34, the hard disk 38, and the interfaces 40, 44 are connected to the input output processing section 28. The input output processing section 28 controls data exchange between the main processor 12 and the sub-processors 14a through 14h and the sound processing section 30, the optical disc reading section 34, the hard disk 38, the interfaces 40, 44, and the network interface 48.

The sound processing section 30 is constructed comprising an SPU (Sound Processing Unit) and a sound buffer. In the sound buffer, various sound data including a game music, game sound effect, and a message read from the optical disc 36 and/or the hard disk 38 is stored. The SPU reproduces the various sound data and outputs via the speaker 32. It should be noted that a built-in speaker of a home-use television set receiver, for example, may be employed for the speaker 32.

The optical disc reading section 34 reads a program and/or data stored in the optical disc 36 according to an instruction sent from each of the main processor 12 and the sub-processors 14a through 14h. It should be noted that the entertainment system 10 may be constructed capable of reading a program and data stored in any computer readable information storage medium other than the optical disc 36.

The optical disc 36 is a typical optical disc (a computer readable information storage medium) such as a DVD-ROM or the like, for example. The hard disk 38 is a typical hard disk device. Various programs and data are stored in the optical disc 36 and/or the hard disk 38 so as to be read by the computer.

The interfaces (I/F) 40, 44 each serve as an interface for connecting various peripheral devices such as a controller 42, a camera unit 46, and so forth. As the interface, a USB (Universal Serial Bus) interface may be employed, for example.

The controller 42 is a general purpose operation input means, and used by the user to input various operations (for example, a game operation). The input output processing section 28 scans the state of the respective sections of the controller 42 every predetermined period of time (for example, 1/60 second) and supplies an operational signal indicative of the result of the scanning to the main processor 12 and/or the sub-processors 14a through 14h. The main processor 12 and the sub-processors 14a through 14h determine the content of the operation carried out by the user based on the operational signal. It should be noted that the entertainment system 10 is constructed capable of connection to a plurality of controllers 42, so that the main processor 12 and/or the sub-processors 14a through 14h carry out various processing based on operational signals input from the respective controllers 42.

The camera unit 46 is constructed comprising a publicly known digital camera, for example, and inputs a captured image in black and white, grey scale, or color every predetermined period of time (for example, 1/60 second). The camera unit 46 in this embodiment is designed so as to input a captured image in the form of JPEG (Joint Photographic Experts Group) image data. The camera unit 46 is placed on the monitor with the lens thereof directed towards the player, for example, and connected via a cable to the interface 44. The network interface 48 is connected to the input output processing section 28 and the network 50, and relays data communication from the entertainment system 10 via the network 50 to another entertainment system 10.

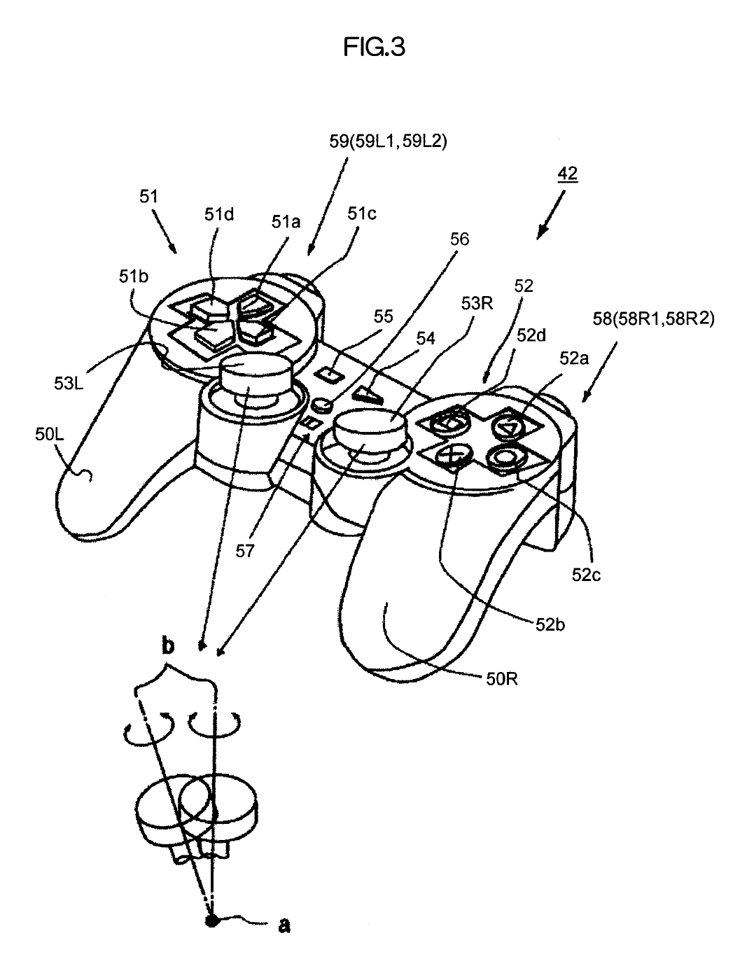

The controller 42 maybe a keyboard, a mouse, a game controller, and so forth. Here, a case in which a game controller is used as the controller 42 will be described. The controller 42 has grip portions 50R, 50L, as shown in FIG. 3. The user grasps these grip portions 50 using their left and right hands. At a position capable of being operated by the user with their thumbs while grasping the grip portions 50, a first operation section 51, a second operation section 52, and analogue operation sections 53R, 53L are provided.

Here, in the first operating section (a direction key) 51, an upper direction instruction key 51a, a lower direction instruction key 51b, a right direction instruction key 51c, and a left direction instruction key 51d are provided. The user can instruct the direction, using these direction instruction keys 51a, 51b, 51c, and 51d, which are specifically used to instruct a direction in which the cursor image moves on the screen, for example. Also, in the second operating section 52, a triangle button 52a having a triangular imprint formed thereon, an X button 52b having an X shaped imprint formed thereon, an O button 52c having an O shaped imprint formed thereon, and a rectangle button 52d having a rectangular imprint formed thereon are provided. These buttons 52a, 52b, 52c, and 52d are assigned with functions in association with an image identified by the cursor image with the movement direction thereof instructed using the direction instruction keys 51a, 51b, 51c, and 51d.

The analogue operating units 53R, 53L are adapted to an operation by being tilted (or a tilting operation) with the point a serving as a fulcrum. The analogue operating units 53R, 53L are also adapted to rotation in the tilted posture around the rotational axis b which is defined as passing through the point a. During an operation in a non-tilting position, these operating units 53R, 53L are held in a standing, untitled position (a reference position), as shown in FIG. 3. When these operating units 53R, 53L are subjected to a tilting operation by being pressed, coordinate values (x, y) on the x-y coordinate which are defined according to the amount and direction of the tilt relative to the reference position are determined and output as an operational output via the interface 40 and the input output processing section 28 to the MPU 11.

The controller device 42 additionally comprises a start button 54 for instructing the MPU 11 to start execution of a program, and a selection button 55 and a mode selection switch 56 for instructing switching among various modes. For example, when a specific mode (an analogue mode) is selected using the mode selection switch 56, the light emission diode (LED) 57 is subjected to light emission control, and the analogue operation sections 53R, 53L are brought into an operation state. Alternatively, when another mode (a digital mode) is selected, the light emission diode 57 is controlled so as to turn off the light, and the analogue operation sections 53R, 53L are brought into a non-operation state.

Further, on the controller 42, a right buttons 58 and a left buttons 59 are provided at positions capable of being operated by the user with their index fingers, or the like, for example, while grasping the respective grip portions 50R, 50L with their right and left hands, respectively. The respective buttons 58, 59 have first and second right buttons 58R1, 58R2, and first and second left buttons 59L1, 59L2, respectively, which are arranged in the width direction on the controller.

In the following, a method for constructing an entertainment system 10 having the above-described hardware structure as a character input device will be described.

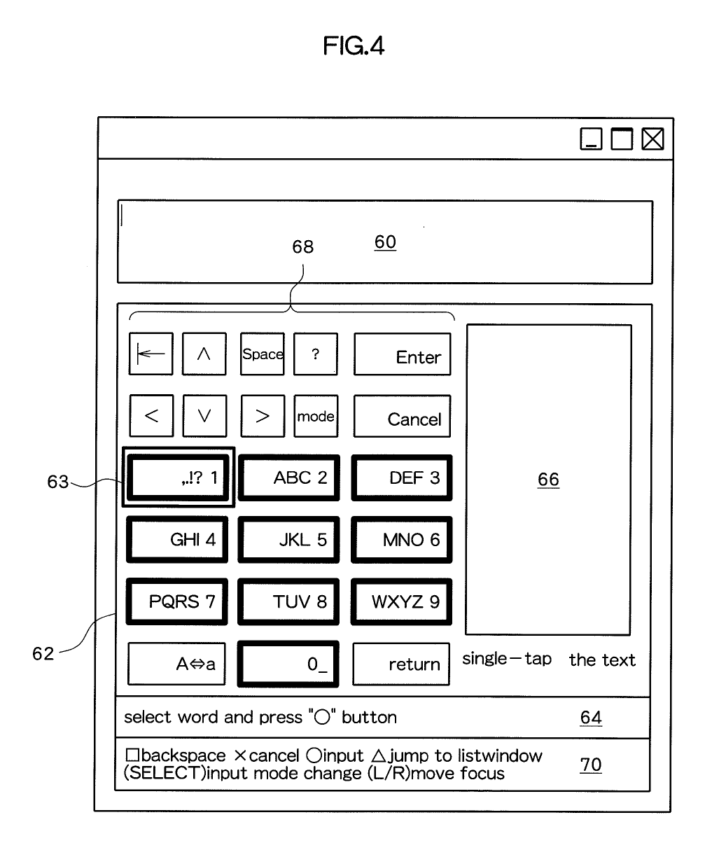

According to this embodiment, a character input interface image is displayed on the monitor 26. FIG. 4 shows one example of the character input interface image. As shown in FIG. 4, in the topmost area in the character input interface image, an input character string display area 60 is defined where a character string input by the user is displayed. Below the input character string display area 60, an operation image 62, a first guidance image 64, and a second guidance image 70 are displayed from the top to the bottom in this order. The operation image 62 is formed comprising a key image alignment 68 which is an alignment constituting of twenty-two key images each standing for a physical key, and a list 66, located on the right side of the key image alignment 68, of predicted character strings prepared based on the input character displayed in the input character string display area 60.

A function is assigned to each of the key images, so that when the user moves the cursor 63 to a desired key image using the first operation section 51 serving as a direction key and presses the determination button (the button 52c here) with the cursor 63 located therein, the function assigned to the key image with the cursor 63 falling thereon is carried out by the MPU 11. For example, by pressing the determination button while the key image with “Space” denoted thereon is distinctively displayed by the cursor 63, a blank can be input into the input character string display area 60. Also, by pressing the determination button while the key image with “Cancel” denoted thereon is distinctively displayed using the cursor 63, one of the characters included in the character string shown in the input character string display area 60 can be deleted.

Here, a plurality of characters are associated with each of the key images enclosed by a thick frame in FIG. 4, in particular, among the key images included in the key image alignment 68. Then, by pressing the determination button while any one of the key images among those is distinctively displayed by the cursor 63, any of the characters set associated with that key image is displayed in the input character string display area 60.

Meanwhile, the predicted character string list 66 shows one or more character strings produced based on the character displayed in the input character string display area 60, so as to be arranged in one direction.

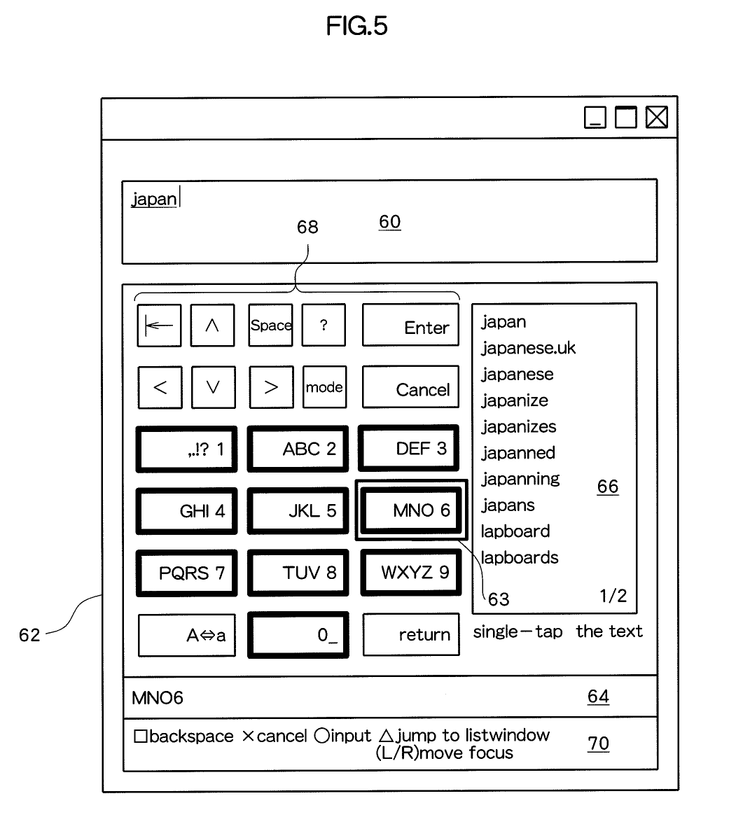

FIG. 5 shows one example of a character input interface image with a plurality of character strings displayed in the predicted character string list 66. FIG. 5 shows a character input interface image which results immediately after the user designates the key images “JKL5”, “ABC2”, “PQRS7”, “ABC2”, and “MNO6” in this order. The key image “MNO6” is distinctively displayed by the cursor 63, and the denotation “MNO6” is shown in the first guidance image 64, indicating that “MNO6” is the current input object.

In this entertainment system 10, one or more English words having the top character being any one of the characters “JKL5”, the second character being any one of the characters “ABC2”, the third character being any one of the characters “PQRS7”, the fourth character being any one of the characters “ABC2”, and the fifth character being any one of the characters “MNO6” are found using an electronic dictionary based on the content of designation of the key images (that is, which key images are designated in which order), and the result is shown in the predicted character string list 66.

The cursor 63 is shown falling on one of all key images and all predicted character strings included in the input character string list 66, to thereby distinctively, that is, discriminably from the rest, display the key image or the predicted character string in the position. In FIG. 4, the key image “,.!?1” is distinctively displayed by the cursor 63; in FIG. 5, the key image “MNO6” is distinctively displayed by the cursor 63. The cursor 63 moves to a key image or a predicted character string on the left, right, upper, and lower side of the present location thereof in response to the press of the keys 51a through 51d of the first operation section 51 being pressed.

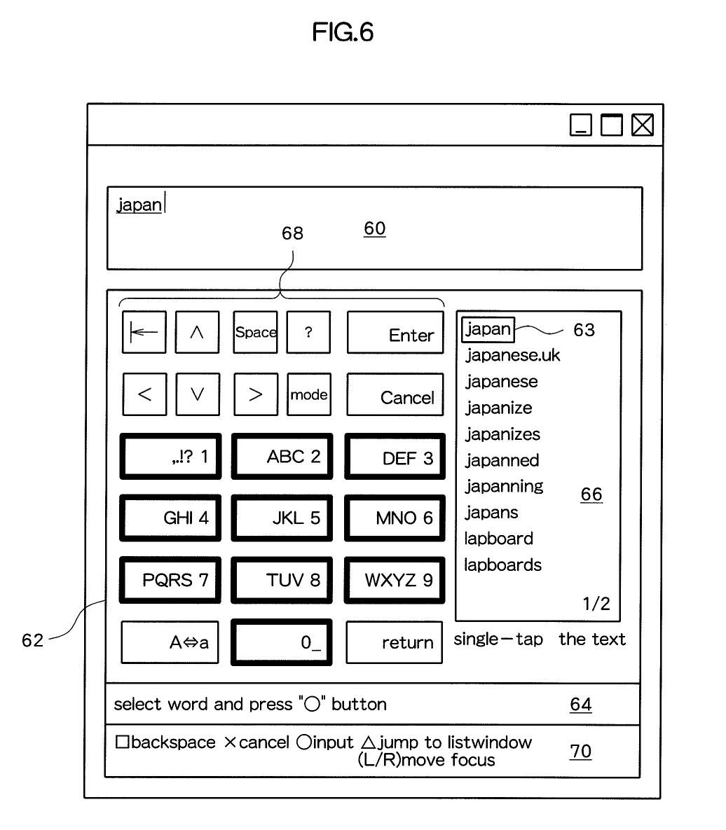

FIG. 6 shows a state in which the cursor 63 has been moved to the predicted character string “japan” in the list 66. That is, when the right direction instruction key 51c is pressed with the cursor 63 located in any of the key images in the column closest to the list 66, where “Enter”, “Cancel”, “DEF3”, “MNO6”, “WXYZ9” and “return” are shown, the cursor 63 moves to any of the predicted character strings shown in the list 66. Meanwhile, when the left direction instruction key 51d is pressed with the cursor 63 located in any of the key images in the column farthest from the list 66, where “|←”, “<”, “,.!?1”, “GHI4”, “PQRS7”, and “A⇄a” are shown, the cursor 63 moves to any of the predicted character strings shown in the list 66.

When the left direction instruction key 51d is pressed with the cursor 63 located in any of the predicted character strings in the list 66, the cursor 63 moves to any of the key images, namely, “Enter”, “Cancel”, “DEF3”, “MNO6”, “WXYZ9”, and “return”, included in the column closest to the list 66. Meanwhile, when the right direction instruction key 51c is pressed in the same situation as the above, the cursor 63 moves to any of the key images, namely “|←”, “<”, “,.!?1”, “GHI4”, “PQRS7”, and “A⇄a”, included in the column farthest from the list 66.

When the cursor 63 moves between the list 66 and the key image alignment 68, position information describing the position of the predicted character string or the key image which is distinctively displayed by the cursor 63 before the movement of the cursor 63 is stored. Then, when the cursor 63 falling on any of the predicted character strings in the list 66 moves to any of the key images in the key image alignment 68, the position to which the cursor is moving is determined based on the previously stored position information. For example, the cursor 63 having moved from the key image “DEF3” to any predicted character string in the list 66 is deemed to return to the key image “DEF3” in response to the left direction instruction key 51d pressed.

Also, when the cursor 63 falling on any of the key images in the key image alignment 68 moves to a predicted character string in the list 66, the predicted character string to which the cursor is moving is determined based on the previously stored position information. For example, when the cursor 63 having moved from the predicted character string “japanese” to any of the key images in the key image alignment 68 moves again to a predicted character string in the list 66, the cursor 63 returns to the predicted character string “japanese” based on the previously stored position information. The above arrangement can facilitate selection by the user, of a key image and/or a predicted character string in the list 66.

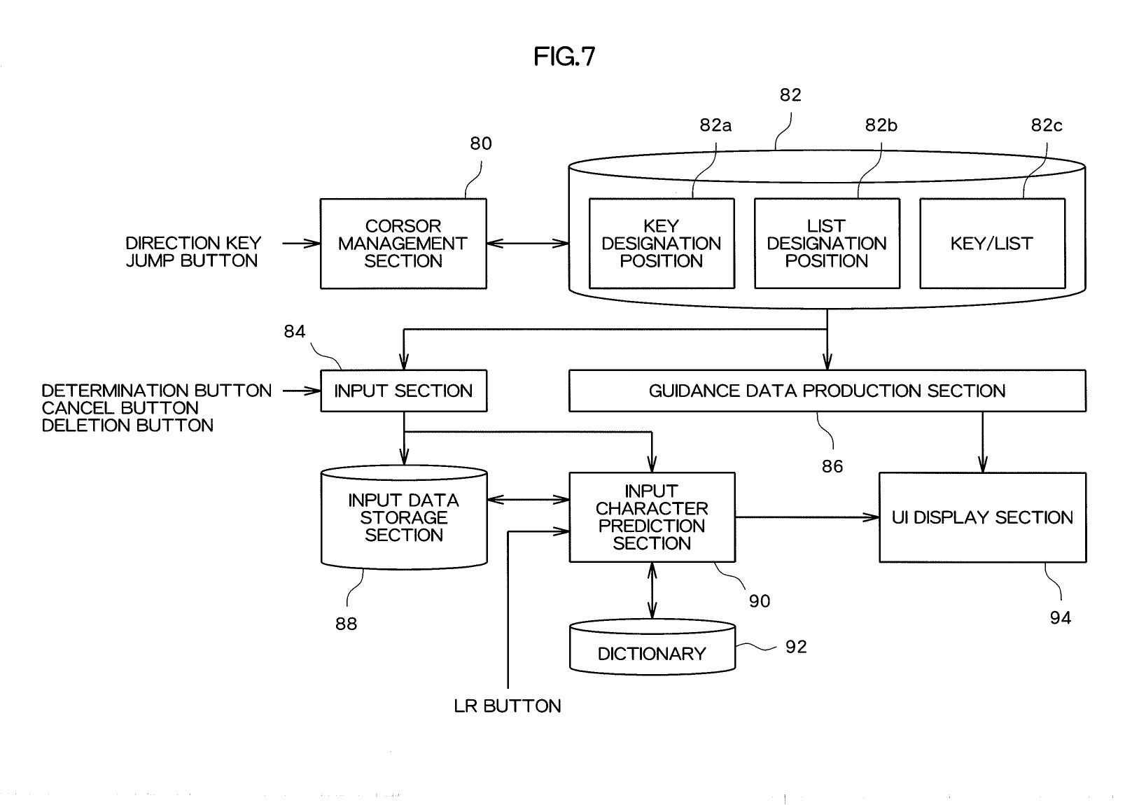

FIG. 7 is a functional block diagram showing the functions realized within the entertainment system 10. The respective functional elements shown in the drawing are realized by the MPU 11 by carrying out a program. This program may be installed into the hard disk 38 of the entertainment system 10 via the optical disc 36, or stored in advance in the ROM (not shown) within the entertainment system 10. Alternatively, the program may be downloaded to the entertainment system 10 via a communication network such as the Internet, or the like.

As shown in FIG. 7, the entertainment system 10 comprises, in terms of functions, a cursor management section 80, a cursor information storage section 82, an input section 84, a guidance data production section 86, an input data storage section 88, an input character prediction section 90, a dictionary storage section 92, and a UI display section 94. The cursor information storage section 82 is formed using the main memory 20 as a main element, and stores a key designation position 82a, a list designation position 82b, and a key/list flag 82c. The key designation position 82a is the position of the key image which was last distinctively displayed by the cursor 63. The list designation position 82b is the position of the predicted character string in the list 66, which was last distinctively displayed by the cursor 63. The key/list flag 82c is a flag for telling which of a key image and a predicted character string in the list 66 was last distinctively displayed by the cursor 63.

The cursor management section 80 receives data indicative of a left, right, upper, or lower direction, input from the first operation section 51 serving as a direction key, and data indicting whether or not the button 52a serving as a jump button is pressed. Then, based on the input data, the content stored in the cursor information storage section 82 is updated.

The guidance data production section 86 produces the content of the first guidance image 64 and the second guidance image 70 based on the content stored in the cursor information storage section 82, and supplies the content to the UI display section 94. Also, the input section 84 receives data indicating whether or not the button 52c serving as a determination button is pressed, data indicating whether or not the button 52b serving as a cancel button is pressed, and data indicting whether or not the button 52d serving as a back space button is pressed. Then, when it is determined that the button 52c serving as a determination button is pressed, the key/list flag 82c is read out to see which of a key image and a predicted character string in the list 66 was last distinctively displayed by the cursor 63.

When it is determined that it is a key image that was last distinctively displayed by the cursor 63, the key designation position 82a is read so that the function assigned to the key image displayed in that position is carried out. In particular, when the button 52d serving as a determination button is pressed with a key image associated with a character distinctively displayed by the cursor 63, input data which identifies that key image is stored in the input data storage section 88.

Meanwhile, when the read key/list flag 82c indicates a predicted character string, the list designation position 82b is read and forwarded to the input character prediction section 90, and the input data stored in the input data storage section 88 is deleted. When it is determined that the button 52b serving as a cancel button or the button 52d serving as a back space button is pressed, a part or all of the input data stored in the input data storage section 88 is deleted.

The input character prediction section 90 predicts an input character based on the input data stored in the input data storage section 88 and using a dictionary stored in the dictionary storage section 92, and forwards the predicted result to the UI display section 94. The prediction result is displayed in the form of a list 66 in the monitor 26 by the UI display section 94.

Alternatively, the input character prediction section 90 having received a list designation position 82b from the input section 84 specifies a predicted character string corresponding to that list designation position 82b, and forwards the data thereof to the UI display section 94. The UI display section 94 additionally displays the predicted character string in the input character string display area 60.

Also, the input character string prediction section 90 receives data indicating whether or not the buttons 58, 59 are pressed. The input character string prediction section 90 having received data indicating that the buttons 58, 59 are pressed replaces the predicted character string in the list 66 by another predicted character string. In this manner, when many character strings are predicted by the input character prediction section 90, all of the predicted character strings can be displayed in the form of a list 66 while sequentially showing parts thereof.

In this embodiment, the cursor 63 can be moved upward, downward, leftward, and rightward, using the first operation section 51 serving as a direction key, to be thereby freely moved across the display positions of all key images and all predicted character strings. This enables designation of a predicted character string in the list 66 using an operation member which is originally used to input a character via a key image. With this arrangement, as the user designates one of the predicted character strings shown in the list 66, it is not necessary to separately provide a physical key. Also, this arrangement enables designation of a character input and a predicted character string through a very simple operation. As a result, a character input interface readily understandable by the user can be realized.

It should be noted that the present invention can be modified into various embodiments.

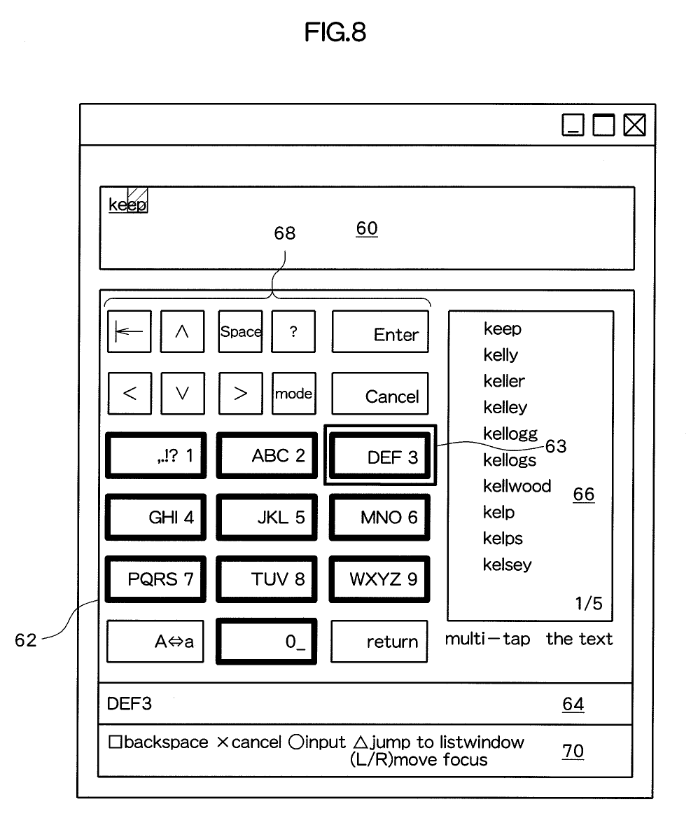

For example, the method for determining an input character is not limited the method described above. Specifically, an input character may be determined depending on the number of times the button 52c serving as a determination button is pressed while maintaining the cursor 63 on, and thereby distinctively displaying, one key image. FIG. 8 shows the state in which the character Ilk“is input by pressing the button 52c serving as a determination button with respect to the key image of “JKL5” twice, and the character “e” is input by pressing the button 52c serving as a determination button with respect to the key image of “DEF3” twice. As a result of the above, the characters “ke” are displayed in the input character display area 60. In addition, a group of words, each beginning with the characters “ke”, is listed by the input character prediction section 90, and shown in the list 66.

What is claimed is:

1. A character input device, comprising:
character input interface image display means for displaying a character input interface image which contains a plurality of key images each associated with one or more characters and a list showing one or more character strings;
distinctive display means for selectively and distinctively displaying one of the plurality of key images and the one or more character strings shown in the list according to a direction operation carried out by the user; and
input character string display means for displaying, when one of the plurality of key images is distinctively displayed by the distinctive display means when the user carries out an input operation, one of the characters associated with the key image in a character string display area, and displaying, when one of the one or more character strings is distinctively displayed by the distinctive display means when the user carries out the input operation, the character string in the input character string display area.

2. The character input device according to claim 1, further comprising
list production means for producing the list showing one or more character strings based on the character string displayed in the input character string display area.

3. The character input device according to claim 1, wherein
the distinctive display means stores, when a distinctive display object is changed from one of the plurality of key images to one of the one or more character strings, display position information concerning a display position of a key image which is the distinctive display object before the change, and determines, when the distinctive display object is changed from one of the one or more character strings to one of the plurality of key images, a key image which is the distinctive display object after the change according to the display position information.

4. A character input method, comprising:
a character input interface image displaying step of displaying a character input interface image which contains a plurality of key images each associated with one or more characters and a list showing one or more character strings;
a distinctive display step of selectively and distinctively displaying one of the plurality of key images and the one or more character strings shown in the list according to a direction operation carried out by the user; and
an input character string displaying step of displaying, when one of the plurality of key images is distinctively displayed at the distinctively display step when the user carries out an input operation, one of the characters associated with the key image in a character string display area, and displaying, when one of the one or more character strings is distinctively displayed at the distinctive display step when the user carries out the input operation, the character string in the input character string display area.

5. An information storage medium storing a program for causing a computer to function as
character input interface image display means for displaying a character input interface image which contains a plurality of key images each associated with one or more characters and a list showing one or more character strings;
distinctive display means for selectively and distinctively displaying one of the plurality of key images and the one or more character strings shown in the list according to a direction operation carried out by the user; and
input character string display means for displaying, when one of the plurality of key images is distinctively displayed by the distinctive display means when the user carries out an input operation, one of the characters associated with the key image in a character string display area, and displaying, when one of the one or more character strings is distinctively displayed by the distinctive display means when the user carries out the input operation, the character string in the input character string display area.
